(19) United States
(12) Patent Application Publication
(10) Pub. No.: US 2006/0101521 A1
(43) Pub. Date: May 11, 2006

(54) System and method for secure usage right management of digital products

(76) Inventor: Shlomo Rabinovitch, Rishon Lezion (IL)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 10/531,839

(22) PCT Filed: Oct. 17, 2002
(86) PCT No.: PCT/IL02/00838

§ 371 Date: Apr. 18, 2005

(51) Int. Cl. H04N 7/16; H04L 9/32; G06F 17/30; G06F 7/04; G06K 9/00; H03M 1/68; H04K 1/00; H04L 9/00

(52) U.S. Cl. 726/26

(57) ABSTRACT

A method and system for management (60) of digital products involving usage rights (66) of combined objects (62, 64, 66, 68, 70).

### BACKGROUND OF THE INVENTION

1. Field of the Invention

The present invention relates to the usage rights management of digital products in general and to the usage rights management of digital products in a substantially secure manner, in particular.

2. Discussion of the Related Art

In recent years there has been an increasing tendency for advanced commercialization of diverse digital products, such as electronically formatted documents, books, images, maps, movies, musical recordings, videos, services, utilities and software applications, accomplished via appropriate commercial transactions and via subsequent electronic delivery of the respective digital products to requesting consumers. The transactions and the resulting distribution are performed between supplier sites and remote consumer sites utilizing electronic data formatted transmissions across global data communications networks. Due to the rapid development, implementation and spreading of data communications network-based digital product distribution infrastructures an increasing number of consumers acquire and use an increasing number of available digital products either on a permanent or on a temporary basis. For example, an accounting software application owned by an application service provider (ASP) could be used by a multitude of consumers word-wide where each consumer activates the application only a few times during a certain period. Another example could regard a document owned by an information service provider that could be delivered to a multitude of consumers for the duration of several hours in order to enable the consumers to learn a specific issue. Yet other examples regard digitally formatted movies, musical recordings, magazines, newspapers and the like that are distributed to interested consumers for a limited number of replays, or for a limited period of usage.

In all the above examples the digital products belong to a specific owner in the legal sense. It is therefore evident that the usage of the product must involve the permission of the owner. The specific owner has the legal right to determine the rules and conditions in regard to the usage of the product. Thus, digital products are typically provided for consumers under specific usage rules and usage conditions that define and delineate the usage rights of the specific product. The usage right definitions include various parameters, such as the identification of the consumer, the number of copies the consumer is permitted to create, the number of times the product could be resold, the number of times the product could be replayed and the like. It is obvious that in order to prevent unauthorized use and unrestricted or unlimited access, the rules and restrictions associated with the product should be suitably enforced preferably in a software-controlled manner. In an ideal world the introduction of relatively straightforward software control functions, such as for example password-controlled access would be sufficient. In the real world the proper enforcement of the product usage rights is highly problematic. The presently operating computer-based communications environments provide a plurality of user-friendly interfaces as well as a plurality of readily available software utilities that allow for substantially easy manipulation of computer files such as the copying of the files, the transferring of the files to an another device, the functional modification of the files, to bypass the password protection for example, and the like. As a commercial digital product comprises typically one or more logically interconnected digital files, to prevent unauthorized or unrestricted usage of a digital product is an extremely complex task, as it should lock several basic processing options inherent in the supporting software. In addition, in the modern public communications network environments a specific type of miscreant entity (typically referred to as a “hacker” or a “cracker”) has emerged that for diverse reasons (financial, personal, professional, social, psychological) continuously attempt to “attack” secure digital files in an illegal manner in order to break down the built-in defenses of the file. Successful attacks, such as for example generating an effective bypass over a password defense function, enable the attacker entity to manipulate the inner structure of the digital file in a malicious manner, such as providing unrestricted access to and unauthorized usage of the digital product embedded within the digital file.

It would be easily perceived that network-based electronic commerce in digital products should involve a suitable mechanism that is capable of defining, controlling and managing the authorization, the usage rights and the accounting of the digital product usage. The mechanism should further provide a robust defense against unauthorized, unlimited and unrestricted access. Practical and efficient electronic commerce and the associated electronic distribution of digital products depend on the following basic features: a) the distribution of the digital products that is performed through the Internet and more specifically the Word Wide Web (Web), b) the redistribution of the products within a specific sector, region, or locality should be enabled, c) the redefinition of the usage rights, restrictions, and the like in accordance with the policy defined by the owner should be enabled, d) the reformatting the original format according to the pre-defined policy should be allowed, e) the addition of new information or data to be used as an integral part of the transaction involving the digital product, such as comments, translations, advertising and the like should be allowed and f) substantially secure management and usage control of the digital product should be provided.

Although the implementation of a combination of the above-described required features is substantially problematic, presently there are several primary techniques to deal with the issue. The operational policy is based on the concept that a product distribution chain is involved that comprises the owner of the product, a group of distributors/resellers and a plurality of end-users. The owner is the first element in the distribution chain that defines the primary rules, rights and restrictions of the usage of the product by defining the policy of the further distribution rights and associated usage restrictions. The next element in the distribution chain is the distributor/reseller. The distributor/reseller in his turn defines his/her own policy and associated restrictions that replace/overlay/modify the definitions of the owner. Finally, a user may use the products in accordance with the rights and restrictions imposed by the owner and/or the distributor/reseller. The user should further be provided with the capability to transfer part of the usage rights to other associated sites/users, such as additional devices, employees, friends, family members and the like.

The distribution chain may include other diverse elements according to the on-going evolution in the field of electronic commerce. The actual operational environment can be considered to include the entire set of known and prospective computing devices and computerized devices with embedded application software controlled by various operating systems. The computerized devices therefore could include entertainment centers, set-top boxes, PDAs, mobile telephones, portable devices, play stations and the like. The computing devices could include a wide variety of hardware devices supported by diverse operating systems, such as Unix, Linux, Windows, PalmOSs and the like. A capability of connecting to external interfaces is required in order to link to the following supporting sub-systems: billing system (for accounting and payment management), archiving system (for the keeping and retrieving of the required digital products), browser applications, communications (for the general interface or to the specific communication system) and other specific required interfaces for diverse specific needs.

Presently the usage rights management of digital products is accomplished by specific control functions implemented in the supplier sites. The control functions control the digital products distributed as remote objects among a plurality of remote sites. The required control features are as follows: a) the control should support variable functionality, b) the controlled object format may be of a plurality of types, c) the controlled object may be transferred to another site to be controlled there, d) the control is not necessarily requires connectivity to the supplier site, e) the communication load should be preferably minimal and f) the Quality of Service (QoS) should be good enough to allow control of the streaming data objects such as video and/or audio.

Presently several control techniques are utilized for the management and control of the digital products. None of the techniques provide the entire set of functional requirements and control features described hereinabove.

Existing traditional methods perform the control operation by utilizing a control communication channel. There are several communication techniques and protocols to implement a communication channel for the purposes of controlling the object remotely.

The majority of the existing control systems utilize a technique referred to typically as “on-line control”. In on-line control the remote object is controlled through a permanently open communication channel. As long as the controlling of the controlled remote object is necessary the communication channel is kept open. The control system utilizes a dedicated control channel to communicate with the controlled content object when the controlling function is performed in accordance with the pre-defined control functionality. In this approach the controlled object is transferred to a remote site, the control functionality definition is implemented on the supplier site and the control procedure is performed during the transmission of the controlled object. In order to achieve and provide a pre-defined level QoS, by necessity the process generates a substantial communication load on the server and on the network. The controlled object is transmitted from the supplier site every time when the remote site needs it. Subsequent to the termination of the operation, the controlled object is removed from the remote site. This technique does not provide the option of transferring the controlled object to a device associated with the remote site, such as a mobile device, without the establishment of a network connection to the supplier site.

The other control approach is typically referred to as “connect-for-use”. The connect-for-use technique involves the transfer of the controlled object to the remote site. When an attempt is made on the remote site to activate the transferred object a specific built-in function is initiated that connects the remote site to the supplier site or to a specific control site in order to acquire suitable permission to use and subsequently operate the controlled object. This technique provides no option for the further transfer the object to a device or site associated with the remote site, such as a mobile device, without an operative connection to the supplier site or the control site. In addition no option is provided for the delegation of the usage right or a part of it to another device or site.

Yet another technique to implement the required functionality of control is typically referred to as “rights package”. The content object is kept in a pre-defined directory on the remote site while a “rights package” comprising the defined rights is kept in a different directory on the remote site. The rights package includes a limited number of parameters, such as authentication and authorization data. In order to enable management and control of the content object via the rights package an association mechanism has to be set up. As the content object is kept separately the opening thereof is a quite straightforward operation and consequently it is relatively simple to bypass the entire set of usage parameters involving usage rights, restrictions, authentication and the like. This technique does not provide the option for usage accounting, for the delegation of usage rights to an associated site and for the integration of add-on information. Thus, a distributor/reseller operating in the distribution chain lacks the basic capability of modifying the usage rights, of defining restrictions and the like.

It would be easily understood by one with ordinary skills in the art that there is an urgent need for a new system and method operative to an improved and secure management of digital products distributed physically across a data communications network and delivered to remote sites and devices via a flexible distribution chain. The new system and method should preferably provide for flexible and dynamic definition of usage rights by the relevant elements in the distribution chain and should preferably involve a minimal load on the network infrastructure. Furthermore it is highly important that the new system and method provide for a substantially secure control and management technique in order to prevent unauthorized, unlimited and unrestricted access to the remote digital products.

### SUMMARY OF THE PRESENT INVENTION

On aspect of the present invention regards a system for the secure control management of digital product usage rights within a communications and computing environment having at least one server device linked communicatively via a communications network to an at least one remote client device. The system comprising the elements of: at least one flexible structure component carrying digital content information and digital content usage control information in an integrative manner; at least one digital product content data record to store original digital content information to be assembled and integrated into the least one flexible structure component, at least one digital product control data record to store digital content usage control information to be assembled and integrated into the at least one flexible structure component, at least one parameter file to hold component access functional extensions to b assembled and integrated dynamically into the at least one flexible structure component, at least one builder sub-system to assemble and create the at least one flexible structure component using the at least one digital product content data record, the at last one digital product content usage control data record and the at least one parameter file and at least one flexible structure component controller to control the operation of the at least one flexible structure component.

A second aspect of the present invention regards a method for the secure distribution digital products and the secure control of digital product usage rights within a communications and computing environment having at least one server device linked communicatively via a communications network to an at least one remote client device. The method comprising the steps of: dynamically and variably assembling an at least one flexible structure component carrying a digital product and having a unique physical structure by an at least builder sub-system utilizing an at least one digital product content record, an at least one digital product control record and an at least one parameter file, repeatedly distributing the at least one assembled flexible structure component to a requesting remote location/remote client device associated with a specific element of a digital product supply chain, repeatedly defining the content usage rights of the at least one flexible structure component for the requesting remote site/remote client device prior to further distribution to the requesting remote locations/remote client devices, repeatedly delegating the rights for defining the content usage rights for the requesting remote locations/remote client devices prior to further distribution to the requesting remote locations/client devices and securely controlling the operation of the flexible structure component by an at least one flexible structure component controller.

### BRIEF DESCRIPTION OF THE DRAWINGS

The present invention will be understood and appreciated more fully from the following detailed description taken in conjunction with the drawings in which:

FIG. 1 is a schematic illustration of a computing and communication environment in which the proposed system and method operates, in accordance with a preferred embodiment of the present invention;

FIG. 2 is a schematic illustration the distribution chain, in accordance with a preferred embodiment of the present invention;

FIG. 3 illustrates the different types of controls provided to the elements of the distribution chain, in accordance with a preferred embodiment of the present invention;

FIG. 4 is simplified block diagram illustrating the system architecture, in accordance with a preferred embodiment of the present invention;

FIG. 5 is a block diagram of the Flexible Structure Component, in accordance with a preferred embodiment of the present invention.

### DEFINITIONS ACRONYMS AND ABBREVIATIONS

AFU—Access Function
Builder—Reseller/Distributor's server-side software
CAFÉ—Component Access Functional Extension
CALM—Component Access Locking Mechanism
Controller—Consumer's client-side software
CSD—Component Structure Descriptor
CVD—Component Version Descriptor
FCS—Flexible Control Component
IP—Internet Protocol
ROC—Remote Object Control
RRD—Rules and Rights Descriptor
SFR—Stamp Formula
SFU—Stamp Function
WDF—Watch Dog Function

### DETAILED DESCRIPTION OF THE PREFERRED EMBODIMENT

A system and method for the secure management of digital products usage rights is disclosed. A combined digital object is prepared for distribution to a remote site associated with an element of a distribution chain on a digital product server site. The combined digital object is assembled by a specifically developed object builder application. The builder generates the object by obtaining a requested content data record, a pre-defined object control data record, an add-on data record, a set of access functions and a set of locking mechanisms and by the combination of the data records into a substantially unique flexible structure component. The building of the component is made in a highly dynamic manner where the manner of the structuring is formed in accordance with a flexible component structure parameter file. The parameter file includes a dynamic set of control functions, control, parameters, structure definitions, formulas, and anti-hacking defense mechanisms. Due to the dynamic manner of the component creation practically each and every specific component having identical functionality is provided with a unique structure.

Consequent to the assembly process the flexible structure component is transmitted via a suitable transmission media to a remote client site associated with an element of the distribution chain in order to be activated and be processed by diverse software applications, such as a client application, a network browser, a text processor, a video player, an audio player and the like. The flexible structure component is controlled regarding the digital product usage rights of the carried digital content by specific control functions and control parameters carried internally within the incorporated object control data. The flexible structure component is provided with a substantially unique set of defense mechanisms operative in the prevention of unauthorized usage, unrestricted access, and illegal tampering by potential malicious manipulators or attackers. The flexible structure component carrying the digital content, the object control and management functions, the control parameters and the additional data provides the option to the element of the distribution chain to dynamically re-define the usage rights parameters of the component for delegating the usage and control of the component to diverse associated devices/sites and to re-distribute the component to the diverse associated devices/sites. As the usage rights control functions and the usage right control delegation functions are embedded within the component the component could be effectively controlled, delegated, re-transmitted, and monitored without the establishment of a communication link with the digital product supplier server. The builder sub-system is capable of functionally interfacing with various support systems, such as a billing system, an archiving system, a communications system, and the like.

The proposed system and method provides several important advantages over the existing systems. The combined digital object is transferred to the targeted remote device/site only once. The object is controlled locally by a specifically designed controller application in association with the built-in control functions, control parameters, usage rights definitions, usage restrictions, and usage right delegation definitions. Controlling of the object does not require the establishment of a communication link with the object supplier site or with a specific controlling site. As a result a high level of Quality of Service is assured and guaranteed. The control parameters of the object can be modified by the proper element in the distribution chain and the object could be re-transmitted to further devices/sites either with a full functionality or partial functionality where the necessity to open a control communication channel is negated. The financial accounting and usage monitoring of the object is done locally and an option to transmit accumulated accounting and payment information back to the object supplier site is provided. When the content object is an application improved data security is achieved as the application could work locally only and thereby the necessity of passing the consumer's private information between the supplier site and the consumer site through the network is avoided. The unique structure of an individual component provides a substantially enhanced defense against hacking activities, such as unauthorized access, malicious manipulation, illegal copying and the like. The uniqueness of the component provides that substantially successful “break-ins” into a specific content carried by the component will not provide the hacker with useful information that could be potentially used during similar future attempts.

In the proposed system and method of the invention, the combined digital object is distributed along the flexible object distribution chain where usage right control and usage right control delegation could be performed at each stage of the distribution. The stages of the distribution chain are associated with different types of entities, such as owner/distributor entities, reseller entities and consumer entities where each type of entity is provided with different capabilities concerning the control of the usage rights and the delegation of the control of usage rights. The usage right control and usage right control delegation capabilities for each type of entity are pre-defined during the component building process. Thus, for example, a reseller entity could be provided with the capability of defining a limited period of use for a product and a limited number of permitted installations of the product prior to distributing the product to a consumer entity. The reseller entity could further delegate some of the usage right controls to the consumer entity such as enabling the consumer entity to restrict the right to print the object to other associated consumer entities (friends, employees, family members). Thus consequent to the reception of the object from the reseller entity the consumer entity could perform a number of pre-defined installations of the object in accordance with the usage rights defined by the reseller entity while optionally restricting the right to print the object to associated consumer entities.

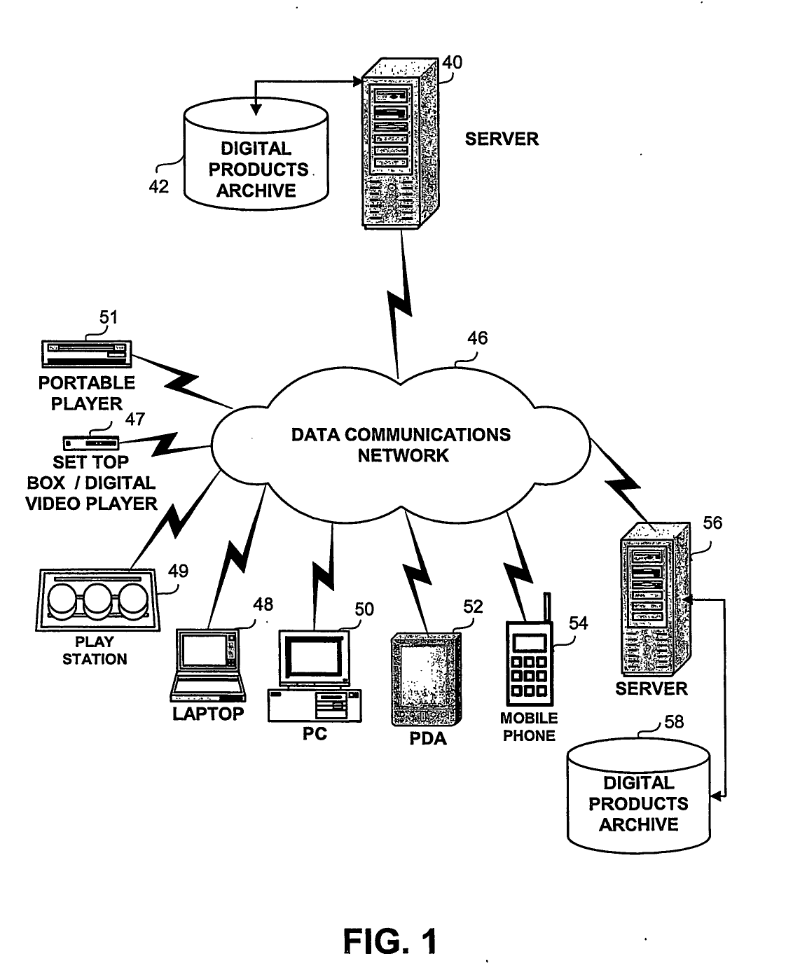

Referring now to FIG. 1 that is a substantially simplified representation of a computing and communications environment within which a preferred embodiment of the present invention could operate. A digital product server device 40 is connected to a set of remote client devices 48, 50, 52, 54, 49 and 51 and a remote server device 56 via a data communications network 46. The remote client devices include a computing laptop device 48, a PC desktop device 50, a Personal Digital Assistance (PDA) device 52, a mobile phone device 54, a play station device 49, a set top box/digital video player 47 and a portable player device 51. The digital product server 40 is linked to a digital products archive 42. The remote server device 56 is also connected to a digital products archive device 58. Consequent to an e-commerce related transaction initiated by one or more remote devices 47, 48, 50, 52, 54, 51, 49 or by the remote server device 56, a request for a specific digital product is introduced to the digital product server 40 via the data communication network 46. The request is suitably processed, verified and confirmed by the server 40. Consequently the server 40 obtains the relevant digital product form the digital products archive 42. A digital object is built by the server 40 in an appropriate manner and the object is transmitted to the requesting remote device 47, 48, 50, 52, 54, 49, 51 or the requesting remote server device 56. Alternatively the request could be introduced to the server 40 by the server device 56 only that is operated by a distributor/reseller element of a flexible distribution chain. Following the transmission of the digital product from the digital product server 40 the remote server 56 receives the digital product and after suitable processing stores the product into the associated digital product archive 58. Consequently the digital product could be re-distributed by the remote server 56 to the requesting remote client devices 47, 48, 50, 52, 54, 49 and 51. The product could be returned by the remote client devices 47, 48, 50, 52, 54, 49, and 51 to the digital product server 40 or to the remote server 56. The usage rights parameters of the digital product could be defined by the digital product server 40 and could be re-defined for re-distribution by the remote server 56 prior to re-transmission of the digital product to the remote devices 47, 48, 50, 52, 54, 49 and 51. The usage rights parameters could be further re-defined under specific restrictions and rules by the remote devices 47, 48, 50, 52, 54, 49 and 51 in preparation for further distribution. The digital product is operated on and controlled locally either on the remote devices 47, 48, 50, 52, 54, 49, and 51 or on the remote server 58 without the setting up of a communication link to the digital product server 40. It will be evident to one in ordinary skills in the art that the proposed system and method provides a substantially enhanced operational flexibility in the orderly distribution of the digital products as well as the dynamic alterations of the usage rights according to each targeted device/site in the network and according to each targeted element in the distribution chain. Note should be taken that although on the drawing under discussion only a single digital product server and a limited number of remote sites are shown in a realistic environment a plurality of digital product server could transmit a plurality of digital products to a plurality of remote devices and remote sites. The remote client devices could include a variety of hardware devices in addition to the ones shown. Remote hardware devices could include entertainment centers, set top boxes, portable devices, play stations, and any other prospective devices under design, development or testing. The devices could incorporate diverse software application programs controlled by embedded operating systems such as Unix and all its variants, Linux and all its variants, all the types and version of Windows, PalmOS, and any prospective operating systems under design, development and testing.

The above described computing and communications environment is exemplary only. Other configurations could be used, for example with a number of digital product servers implemented to provide optimal load sharing. The limits of the invention are defined only by the attached claims.

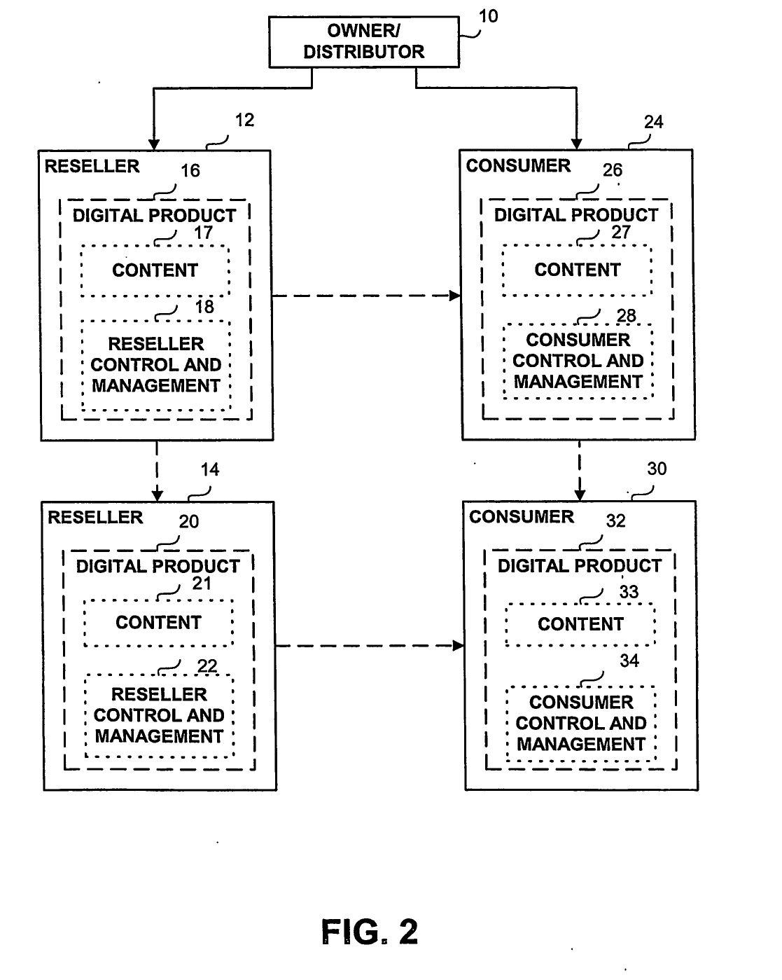

Referring now to FIG. 2 FIG. 2 the owner/distributor 10 of the digital products 16, 20, 26 and 32 is the first element in the distribution chain. The owner/distributor 10 typically operates the digital product server 40 of FIG. 1. The owner/distributor 10 could transmit a requested digital product to the reseller 12 and/or to the reseller 14 and/or to the consumer 24, and/or to the consumer 30. Although for ready understanding of the distribution chain the drawing under discussion illustrates only a single owner/distributor and a limited number resellers and consumers it will be easily perceived that in a realistic environment a plurality of owners/distributors could distribute a plurality of digital products to a plurality of resellers and a plurality of consumers. The reseller 12 operates a remote server site. The reseller 12 and 14 are shown with the digital products 16, 20 respectively received from the owner/distributor 10. The digital products 16, 20 include specific content objects 17, 21 respectively, such as a text document, a video recording, an audio recording, still images, service software, utility software, application software and the like. The digital products 16, 20 further include reseller control and management objects 18, 22 respectively. The objects 18, 22 enable the reseller 16, 20 respectively to control and manage the usage rights and to delegate usage rights of the content object 17, 21 respectively. The reseller 12, 14 is provided with the option of re-distributing the digital products 16, 20 respectively to other resellers and to consumers 24, 30. Prior to the re-distribution the resellers 12, 14 could re-define the usage rights of the digital products 16, 20 respectively in order to modify the usage rights of the products in accordance with the specific rules and restrictions. The consumers 24, 30 are the end-users of the digital products and operate remote devices/sites. The consumers 24, 30 shown with the digital products 26, 32 respectively that were received either from the resellers 12, 14 or directly from the owner/distributor 10. The digital products 26, 32 include specific content objects 27, 33 respectively, such as a text document, video file, audio file, still images, service software, utility software, application software and the like. The digital products 26, 32 further include consumer control and management objects 28, 34 respectively. The objects 28, 34 enable the consumers 24, 30 respectively to control and manage the usage rights of the content object 27, 33 respectively. The consumer 24, 30 is provided with the option of further re-distributing the digital products 26, 32 respectively to other consumers. Prior to the re-distribution the consumers 24, 30 could re-define the usage rights of the digital products 26, 32 respectively in accordance with the rules and restrictions defined by and delegated from the owner/distributor/resellers.

The above description illustrates the enhanced flexibility provided by the proposed system and method. The digital product carries an embedded control and management object within. As a result the digital product could be controlled locally on each site and device that provides the option of modifying the usage rights of the digital products at each stage of the distribution by each of the elements of the distribution chain operating different sites/devices. Preferably different elements of the distribution chain are provided with different product control and management options. The basic product usage rules, definitions and limitations are defined by the owner/distributor in a comprehensive manner and embedded into the digital products during a specific product building stage. The resellers have a more limited capability of re-defining a specific subset of the usage rights definitions while the consumers have yet an even more limited capability for the modification of another subset of the usage rights definitions.

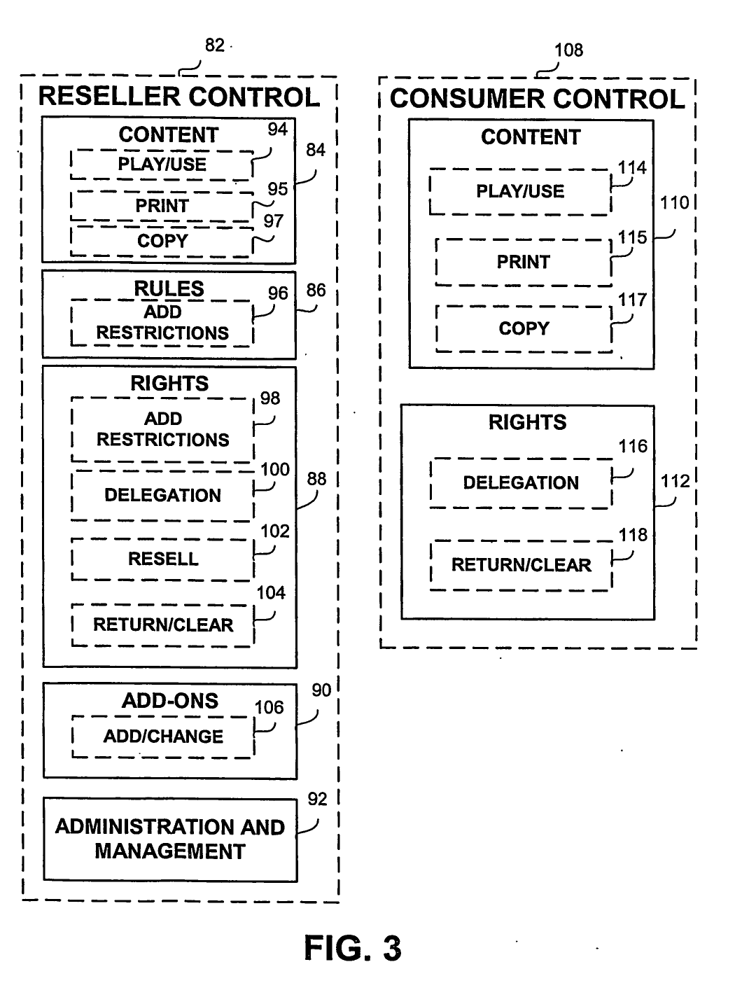

Referring now to FIG. 3 that illustrates the different types of the controlling options that are provided by the proposed system and method to the different elements in the distribution chain. As clearly demonstrated by the drawing the resellers are provided with extensive control 82 capabilities. The extended control and management options provided to the reseller reflect the central role of the reseller in the distribution chain. A reseller is typically operates as the “work horse” of the chain. The reseller is in extensive contact and communication with a plurality of owners/distributors, a plurality of resellers and a plurality of consumers. The reseller typically distributes the same product to several consumers where each product could be given different usage rights. Thus, the reseller needs the capability of rules re-definition, usage rights modification and add-on handling. The reseller is further obligated to manage an accounting process regarding the distributed products where the accounting and payment handling concerns both the consumers and the owners/distributors. The reseller has to manage the requests of the consumers, process and submit the requests for the supply of the digital products to the owners/distributors, monitor the requests against the supply, transmitting the requested items to the consumer and the like. Thus, the reseller control 82 capabilities includes digital content handling 84, rules modification 86, usage rights manipulations 88, add-ons insertion and modification 90 and administration and management functions 92. The content handling option 84 enables the reseller to play 94 the content for the purposes of content examination and verification, to copy 97 the product and to print 95 the product. The rules generated by the owner/distributor could be re-defined by the adding of usage restrictions 96. The usage rights can be modified by adding restrictions 98, by delegating usage rights 100 to other resellers, by reselling 102 the product to consumers and by returning or clearing 104 specific products. The reseller could insert additional information into the digital product by adding or changing 106 data. The reseller administers and manages 92 the stock of digital products received from several different owners for the purposes of monitoring, accounting, payments and the like.

Still referring to FIG. 3 in contrast with the reseller control 82 the consumer control 108 provided a substantially limited control options. The consumer is typically the end-user within the distribution chain. Thus, the consumer control includes content manipulation 110, such as playing/using 114 the content, copying 117 the content, printing 115 the content, and a restricted number of control options such as rights control 112. The rights control 112 enables the consumer to delegate 116 the usage right to one or more associated devices/sites, such as mobile devices, employee workstations and the like. The delegation 116 could involve a minimal amount of usage rights modifications. The reselling of the product and the delegation of the usage rights of the product is agreed upon and confirmed by the reseller. The consumer is further enabled to return/clear 118 an unused or unsold product either to the reseller or directly to the owner/distributor.

Note should taken that the above description is exemplary only. In other preferred embodiments of the invention the reseller and/or the consumer could be provided with different control options, additional control option could be added and several options could be dispensed with.

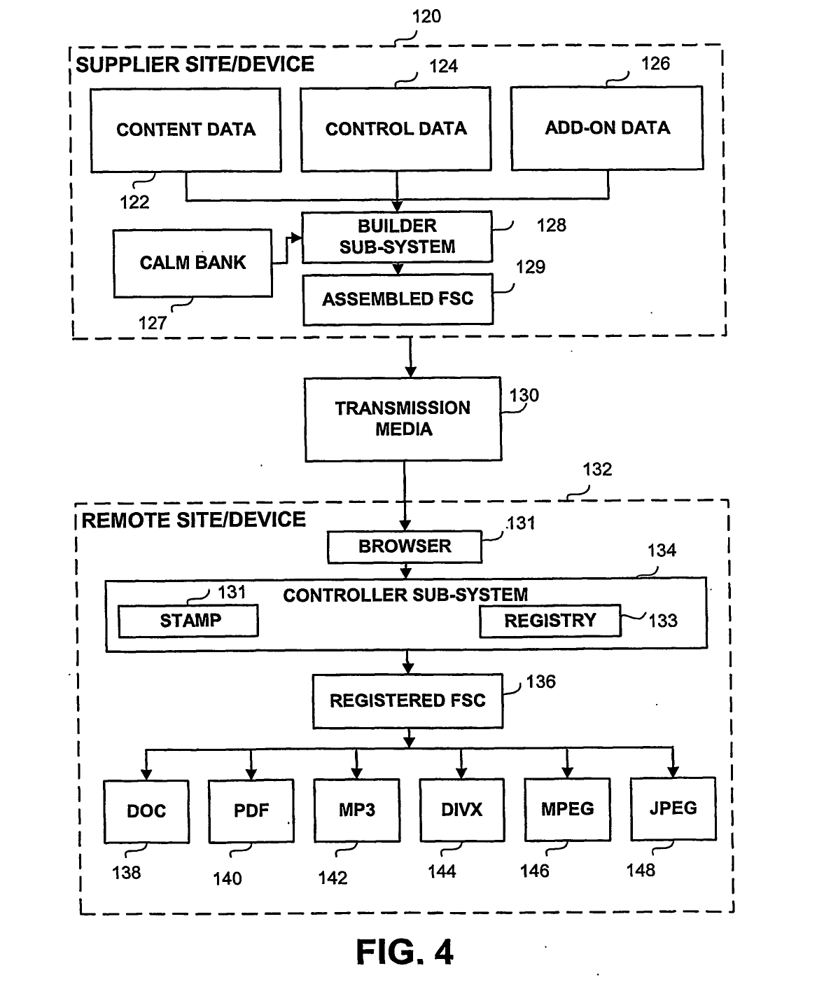

Referring now to FIG. 4 that illustrates a simplified and exemplary usage rights management system architecture. The system includes a supplier site/device 120, a remote site/device 132 and a transmission media 130 linking communicatively the supplier site/device 120 with the remote site/device 132. The device/site 120 is operated by a digital product owner/distributor/reseller for the specific purpose of receiving requests for specific digital products from the remote site/device 132, to generate or assemble the requested digital product and the transfer the product to the requesting remote site/device 132 via the transmission media 130. The supplier site/device 120 includes a content data record 122, such as a text document, an e-book, a digital music recording, a video recording, a still image, an application software and the like, an add-on data 126, such as an advertisement, a translated text, a sub-title, and the like and a control data record 124. The control data record 124 comprises diverse digital product related control functions, control routines, control parameters and control tables. The supplier site/device 120 further includes a digital product builder sub-system 128, and a Component Access Locking Mechanism (CALM) bank 127. The builder sub-system 128 is a software application for the generation of an assembled FSC 129. The builder sub-system 128 creates the assembled FSC 129 by obtaining the suitable content information from the content data record 122, from the add-on data record 126 and the control data record 124. The manner of the assembling of the component 129 is determined by the appropriate functions of the builder 128 utilizing the CALM bank 127. The CALM bank 127 contains a specifically organized list of control object identifications, control function identifications and control parameter identifications. The builder 128 assembles preferably each assembled FSC 129 in a unique manner where each FSC 129 is given a different inner structure while having the same operational logic. When completed the assembled FSC 129 includes the digital content data record, the add-on data record and the associated control objects, control functions and control parameters utilized for the controlling and the managing of the FSC 129 at the remote site/device 132. The component 129 includes the entire set of objects needed for the specific implementation and application. The assembled FSC 129 is transmitted to the remote site/device 132 via the transmission media 130. In the preferred embodiment of the invention the transmission media 130 is a data communication network although in other embodiments of the invention diverse other transmission media could be used, such as a cellular network, a cable television network, a satellite communication network and the like. The assembled FSC 129 is received by the remote site/device 132 that is a computer-based device, a computerized portable device and the like. The remote site/device 132 may include a network browser 131, and a controller sub-system 134. The browser 131 is utilized as the communications network interface. The browser 131 receives the assembled FSC 129 and activates the controller sub-system 134 for the suitable handling and processing of the assembled FSC 129. The controller 134 effects a registration process regarding the FSC 129 and registers the component identification into the registry file 133. Subsequently the controller obtains the component structure-specific information from the component 129, decodes the content data, examines the usage rights and validates and authorizes the use of the FSC 129 on the site/device 132. The client application accesses' the FSC, loads the FSC into the memory and activates a new process. The content from the FSC is processed by the suitable applications in accordance with their content format. Thus, a content in a DOC format 138 is processed and executed by the Word text editor or the like, a content with the PDF format 140 is processed and execute by a PDF viewer application, an MP3 file 142 is played by an appropriate audio player software and the DIVX formatted content 144, the MPEG formatted content 146 will be processed by suitable video player software. Following the appropriate processing of the relevant content the FCS 136 will remain in the storage area of the remote site/device 132 for future processing. Each time the registered FCS 136 is activated by the operating system of the device/site 132 the controller 134 is activated in order execute the suitable control functions dynamically embedded in the registered FCS 136. The control functions are operative in the examination of the current usage rights, in the checking of the software stamps embedded in the FCS 136, and in the decoding the content data. The controller sub-system 134 further includes a copy of a stamp 131. A more detailed description of the structure and functionalities of the registered FCS 136 will be provided herein after in association with the following drawings.

Note should be taken that the assembled component 129 is the digital product. The assembled FSC 129 carries the operative content of the product as well as a set of control and management functions utilized for the controlling of the product on the remote site. The assembled FSC 129 is provided with a flexible structure by the builder of the supplier site/device using the control functions, control parameters and defense mechanisms stored in the of CALM bank 127. The concept of flexible structure refers to diverse physical arrangements of the operative objects constituting the component. Thus, one FCS 136 could be arranged in such a manner that the content is placed in the first blocks of the component while another FSC 136 could carry the content in the last blocks of the component. In such a manner each constituent object within the FSC 136 could be placed into any of the consecutive blocks of the component. The responsibility of the controller is to access and obtain each diversely located object from the current blocks in accordance with component structure definition information also carried within the component.

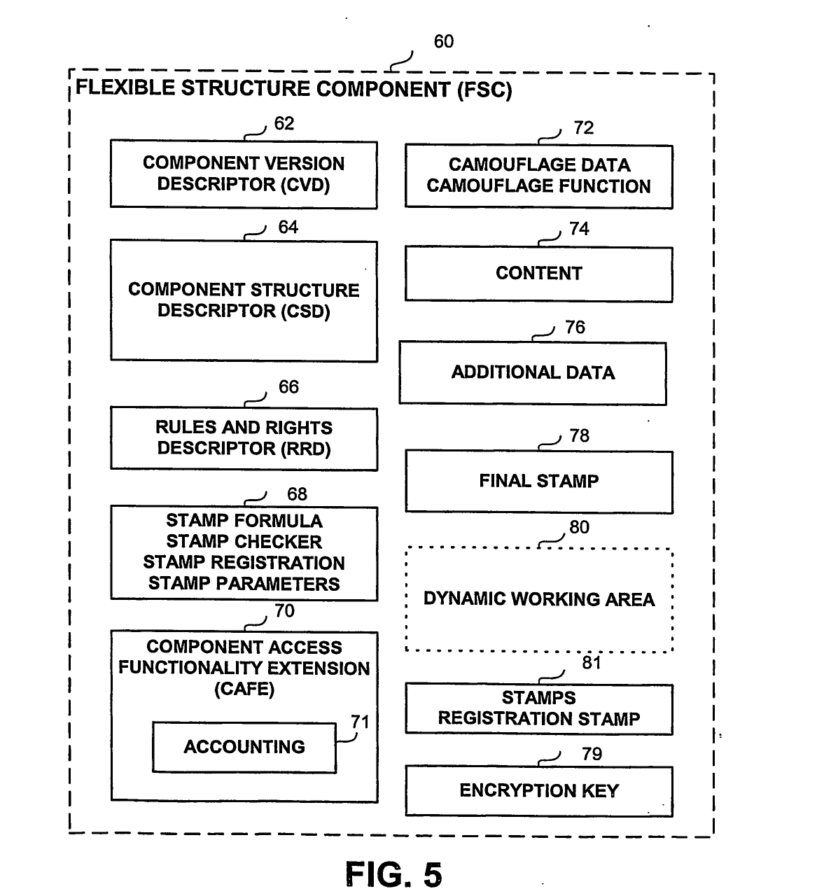

Referring now to FIG. 5 the Flexible Structure Component (FSC) 60 includes a Component Version Descriptor (CVD) 62, a Component Structure Descriptor (CSD) 64, a Rules and Rights Descriptor 66 (RRD), a stamp function 68, a camouflage function 72, a content file 74, additional data file 76, a final stamp 78, a dynamic working area 80, a stamping storage 81, a an encryption key 79 and a Component Access Functionality Extension (CAFÉ) 70. The CAFÉ 70 includes an accounting sub-system 71. The CVD 62 includes the identification of the type of the component and the version of the component. The CVD 62 further includes the description of the CSD language. The CSD language stores the description, allocation and other specific parameters of the objects embedded flexibly in the FSC 60. The RRD 66 describers and specifies the rules, rights, restrictions, functionality parameters and the like that are allocated to the FSC 60. The RRD 66 is based on a changeable language scheme that defines the lifetime, rights, restrictions and other definitions. The dynamic working area 80 is a changeably located memory region where the accounting, tracking, working parameters, and other information are kept for storage, update and retrieval. The area 80 could also be used for the camouflage of other constituent objects, such as the content 74, the RRD 66 and the like. The stamping storage 81 is used to store the stamps. The stamps are utilized for controlling the critical objects of the FSC 60. The critical objects are stamped for the purpose of unauthorized access and malicious manipulation detection. The sum of the stamps is used to generate a final stamp. The set of stamps is used to prevent unauthorized modifications in the structure, functionality and logical flow of the FSC 60. The final stamp 78 is a value generated by summarizing the entire set of stamps stored within the component. The function of the final stamp 78 is the generation of additional defense against unauthorized changes in the structure, the logical flow and the functionality of the FSC 60. The stamp function 68 includes the stamp formula, the stamp checker, the stamp registration routine and the stamp parameters. The stamp formula and stamp parameters indirectly define the manner of calculating a stamp. Both the formula and the parameters could be changed dynamically from component to component. The calculation of the stamps could be achieved by the utilization of different known mechanisms, such as the 16-bit checksum calculation, the CRC mechanism with different polynomials and the like. The camouflage function 72 is used to hide specific information, to prevent the identification of the headers in the content. The content 74 is the main payload of the FSC 60. The content 74 could include text, pictures, drawings, music, video, services, applications, animations and the like. The content 74 is typically encoded by the utilization of diverse encoders. The content 74 is further encrypted by the encryption key 79. When the content 74 is an application it could operate as a software program on a computerized media. The additional data 76 is additional information incorporated into the FSC 60. The data 76 could be advertising material, promotions, translations, comments and the like. The encryption key 79 is used for content encryption and other data encryption. The accounting sub-system 71 is responsible for the performance of the various accounting functions, payment calculations and execution. The CAFÉ 70 is a specifically developed set of software functions that is performed at specific stages in the operation of the FSC 60 in accordance with the definitions and conventions used in the specific application. The CAFÉ 70 is component-specific and is used to provide additional access functionality to the FSC 60. The additional access functionality is inoperative without the utilization of the suitable extensions constituting the CAFÉ 70.

The above description is exemplary only. Additional sub-systems, functions and routines could be added to the FSC, some sub-systems, routines and function could be eliminated, while others could be combined. The flexibility of the component is achieved not only through the physical variation of the location but also through the selective embedding and selective implementation of the objects constituting the component. The changes in the physical structure, in the selection and utilization of the different objects incorporated within can be made at every distribution according to a grouping logic or periodically along the time axis. The flexibility of the component provides an improved protection against the activities of unauthorized entities attempting to attack the component in order to achieve illegal copying, malicious manipulation of the functionality and the like. As substantially every component is provided with a unique physical structure, with a unique combination of operative objects and a unique combination of defensive means unauthorized access and manipulation becomes substantially more complex.

The principal defensive means against unauthorized access and manipulations is the flexible structure of the component. The flexible structure allows changing of the component structure without changing the builder or the controller. To provide for the proper operation of the builder and the component it is sufficient to update the CSD 64 only. The stamps provide further defense as a change in a stamped object will be easily recognized and acted upon. The final stamp is another obstacle for changing one of the objects even consequent to the changing of the object stamp. If the final stamp is modified then the copy of the final stamp incorporated in the controller will indicate an unauthorized access and manipulation attempt by comparing the final stamp in the component to the final stamp copy in the controller. The described defensive means could be enhanced by additional mechanisms.

The proposed system and method provides enhanced security in the operation of the usage right management. The assumption is that practically the entire set of existing and future protective mechanisms could be broken eventually. Therefore the present invention offers a technique to make the task of an unauthorized entity harder by presenting at each and every break-in attempt a unique component. As a result the illegal manipulator is unable to use the information and experience gathered during previous successful or partly successful breaking attempts for an additional component.

Next some of the proposed mechanism operative enhancing the secure digital rights management of the digital products will be described in accordance with a preferred embodiment of the present invention. The techniques described regard specific known problems involved in the protection of digital files.

Print screen key cancellation: The print screen key may be used to print a document without permission. The cancellation of the key function will prevent this operation in a straightforward manner by using specific functions of the operating system or the driver of the keyboard device. Thus, the implementation of the print screen key cancellation is device or operating system-specific.

Component registration: The component should be registered in order to receive the support of the controller. Unregistered FSC win not be recognized by the controller and therefore could not be activated. The registration operation is accomplished following the stamping of the component with a registration stamp and the insertion of the component key into the registry of the controller. Registration can be performed only once and a component with a registration stamp will be prevented from registering again even from a different device. To enable re-registration the registration stamp should be modified prior to the retransmission of the component to another site/device if permitted. Registration could be performed either automatically or off-line. Automatic registration is effected by the browser device utilizing the controller when the component is received. Off-line registration involves registration time limitation. The allowed period between the receival of the component to the performance of the registration is pre-defined. When an attempt to off-line registration is attempted the elapsed time is measured and compared to the allowed time limit. An out-of-time-limit registration attempt will be aborted.

Camouflage: The camouflage process is used to hide critical object within the component. Several techniques could be used, such as an XOR function performed on the required object with preferably randomly generated data. The potential objects to be camouflage are: the CSD, the content headers, the RRD, the stamp formula and the like. The camouflage process could include additional features, such as using the dynamic working area for camouflage, to fill the area with random data prior to registration, to re-camouflage objects and the like. The camouflaging function is changeable from component to component and the XOR function could be replaced by different logical and mathematical formulas to hide the real data. The camouflaging data could be changed during the content usage process and the content could be re-camouflaged with the new camouflage data.

Structure changing: The structure of the component is changed on a periodical or other basis. The present structure is defined in the CSD and therefore there is no need to update the controller with a structure change. The controller obtains the specific structure definition from the CSD. The CSD definitions are generated in predefined and changeable language scheme. The changing of the structure will re-shuffle the operative offset values of the objects within the component.

Language schemes: The communication between the builder and the controller is based on the conventions of a language. For example, the sentence “Rules and Rights Descriptor allocation is 2507” is actually represented by the values “08 25 07” where the number 08 in the CSD represent the RRD start address. In the proposed system and method the language scheme is changed periodically. A set of language schemes are defined and indexed. The CSD of the component is generated by using of the schemes out of the set of language schemes. The index of the language scheme is embedded into the component before the transmission. When the controller of the remote site/device opens the component the language scheme index is obtained and the suitable language scheme is loaded. The component could be controlled and executed only by using the right language scheme. The set of language schemes are stored within the controller device. Different language schemes could be used for different objects within the same component. In other preferred embodiments of the invention the language schemes could be stored within the component in association with a specific language scheme function object. A language scheme can be generated by assigning to each keyword a value from 0 to 255. The next language scheme may be achieved by reshuffling the 256 values and assigning the keywords different values.

Stamps: All the critical objects of the component are stamped. Stamps are computed by utilizing different techniques that may be changed periodically. The simple stamp is for example a checksum of a block that could be kept at the start or at the end of the bock. The technique to compute a stamp is defined in the stamp formula or it may be defined in the RRD. The stamps represent the data in a block. If the data is changed illegally the stamp will not be updated and the illegal attack attempt will be discovered. The final stamp represents the sum of all stamps and it is kept both in the component and the controller. The stamp function is assembled into the FSC from the CALM bank according to the assembling policy and used at the remote device/site.

Component Access Functional Extensions (CAFÉ block): The CAFÉ block includes specific access functions. All access to the component is performed via these functions. The functions check the required access, permissions, authentications and the like and subsequently enable or disable the requested operation. For each different component different access functions are utilized therefore the breaking of one access function by an unauthorized entity do not guarantee an automatic access to another component. Different access mechanisms are combined periodically on the digital product server and introduced into the components dynamically during the building stage.

Watch dog: The watchdog mechanism is responsible for continuously checking that the controller software objects are performing in an appropriate manner and are not bypassed. The working parts shall stamp their working account and the supervisor part will check if all the parts performed stamping. Where one or more stamps are missing the supervisor part recognizes the condition as one associated with a hacking operation and appropriate instructions are executed. The watchdog mechanism uses a known mechanism wherein one task increases a counter and another task resets the same counter. The controller and the FSC check each other via this mechanism in order to make sure that both work properly.

CALM Bank: The proposed system and method provides the option of defining an assembler policy in which each newly built component is assembled in a different manner. The differences concern all the aspects of the component creation: the structure, the computing, the encryption the camouflage parameters as well as functionality and implementation. The same functionality could be implemented in a variety of ways, such as using two functions having different coding schemes for the same purpose. To frustrate the attempts of an unauthorized entity in breaking into the component the operative functions of the component could be dynamically replaced by other functions providing the same functionality and implementation but coded in a different manner. The dynamic allocation of the different functions to different components is achieved via a generic interface between the controller software installed in the remote site/device and the FSC. On the digital product supplier server a CALM bank is established. The CALM bank contains a set of mechanisms, such as randomly organized functions, parameters and structure definitions. When assembling a new component the builder accesses the CALM bank and randomly obtains a record. The record is utilized for indicating to the builder the type and identification of the functions, parameters and structure definitions used in the building of the component. As a result each newly created component having the same functionality will be substantially different in terms of operation, implementation, structure and the like. The CALM bank could be implemented as a simple table, a sophisticated database or any other kind of known data structure. A CALM record for example could store the following information: structure order, camouflage data, CSD language scheme, RRD language scheme, CALM functions and definitions, players list and the like. The CALM functions and definitions list could include for example: the CSD access function, the RRD access function, the stamp formula, the watch dog function and other CALM and CAFÉ functions.

The selection of the options from the CALM bank is made on a random basis or by any other policy. The selection could be made among different records or by selecting one option out of every different record. Additional mechanisms and functions could be added by introducing more records and fields into the CALM bank. Thus, the CALM bank could be periodically upgraded by the addition of new, advanced mechanisms and functions and/or by the replacement of the existing mechanisms and functions with improved versions of the same.

It will be appreciated by persons skilled in the art that the present invention is not limited to what has been particularly shown and described hereinabove. Rather the scope of the present invention is defined only by the claims, which follow.

I claim:

1. In a communications and computing environment having at least one server device linked communicatively via a communications network to an at least one remote client device, a system for the secure distribution of digital products and the secure control management of digital product usage rights, the system comprising the elements of:
at least one flexible structure component comprising digital content information and digital content usage control information in an integrative manner;
at least one digital product content data record to store original digital content information to be assembled and integrated into the least one flexible structure component;
at least one digital product control data record to store digital content usage control information to be assembled and integrated into the at least one flexible structure component,
at least one parameter file to hold component access functional extensions to be assembled and integrated dynamically into the at least one flexible structure component;
at least one builder component to assemble and create the at least one flexible structure component using the at least one digital product content data record, the at last one digital product content usage control data record and the at least one parameter file; and
at least one flexible structure component controller to control the operation of the at least one flexible structure component.

2. The system as claimed in claim 1 further comprises a least one add-on data record to be assembled and integrated into the at least one flexible structure component by the at least one builder sub-system is provided.

3. The system as claimed in claim 1 wherein the flexible structure component is dynamic, whereby protection against the activities of unauthorized entities attempting to achieve illegal manipulation.

4. The system as claimed in claim 1 wherein the digital product content data is encoded by at least one encoder function and by at least one encryption key.

5. The system as claimed in claim 1 wherein the at least one digital product content data record is an electronic document.

6. The system as claimed in claim 1 wherein the at least one digital product content data record is a video recoding.

7. The system as claimed in claim 1 wherein the at least one digital product content data record is an audio recording.

8. The system as claimed in claim 1 wherein the at least one digital product content data record is a software application.

9. The system as claimed in claim 1 wherein the at least one digital product content data record is in a rich media format.

10. The system as claimed in claim 1 wherein the at least one flexible structure component comprises the elements of:
a component version descriptor for the storing of the type, version and the identification of the component;
a component structure descriptor for storing the description and allocation of the diverse parts of the components;
a rules and rights descriptor;
a stamp creation formula to be used for the calculation of the stamps;
a stamp checker function to check the availability and validity of the stamps;
a stamp registration function;
at least one stamp parameter to define the manner of stamp calculation;
at least one digital content data record;
at least one additional data record to store advertising material, promotions, translations and comments;
at least one stamp record;
a registration stamp record to signify suitable registration of the flexible structure component;
a final stamp record to store the value representing the sum of the at least one stamp;
an encryption key to be used for encrypting the digital product content record;
a component access functionality extension.

11. The system as claimed in claim 10 wherein the flexible structure component further comprises a dynamic working area to the storage, update and retrieval of accounting, tracking, camouflage data and working parameters.

12. The system as claimed in claim 10 wherein the flexible structure component further comprises at least one camouflage data record to be used for camouflaging the digital product content record.

13. The system as claimed in claim 10 wherein the flexible structure component further comprises at least one camouflage function to hide specific information and to prevent identification of content headers.

14. The system as claimed in claim 10 further includes at least one add-on information record to hold advertisement information, comment information, translation information and promotion information.

15. The system as claimed in claim 1 wherein the at least one parameter file comprises the elements of:
at least one digital product access control function;
at least one digital product access parameter;
at least one flexible structure component structure definition;
at least one defense mechanism to prevent unauthorized usage, unrestricted access and illegal tampering.

16. The system as claimed in claim 1 further comprises the elements of:
at least one client application;
at least one network browser;
at least one text processor;
at least one video player;
at least one audio player.

17. The system as claimed in claim 1 wherein the at least one builder sub-system further comprises the elements of:
a billing system interface;
an archiving system interface;
a communication system interface.

18. The system as claimed in claim 1 wherein the at least one client device is a personal computer.

19. The system is claimed in claim 1 wherein the at least one client device is a mobile phone device.

20. The system as claimed in claim 1 wherein the at least one client device is a play station device.

21. The system as claimed in claim 1 wherein the at least one client device is a portable player device.

22. The system as claimed in claim 1 wherein the at least one client device is a set top box/digital video player.

23. The system as claimed in claim 1 wherein the at least one flexible structure component is provided with a unique physical structure, a unique combination of operative object and a unique combination of defensive mechanism.

24. The system as claimed in I claim 1 further comprises a language scheme to provide for secure communication between the at least one builder sub-system and the at least one flexible structure component controller.

25. The system as claimed in claim 20 wherein the language scheme is updated periodically.

26. The system as claimed in claim 1 further includes a watch-dog function to examine substantially continuously the appropriate operation of the flexible structure component and the flexible structure component controller.

27. The system as claimed in claim 1 wherein the parts constituting the flexible structure component form a securely distributable and controllable digital product.

28. In a communications and computing environment having at least one server device linked communicatively via a communications network to an at least one remote client device, a method for the secure distribution of digital products and the secure control of digital product usage rights, the method comprising the steps of:
dynamically assembling an at least one flexible structure component comprising a digital product and having a unique structure by an at least one builder sub-system utilizing an at least one digital product content record, an at least one digital product control record and an at least one parameter file;
distributing the at least one assembled flexible structure component to a requesting remote location/remote client device associated with a specific element of a digital product supply chain;
defining the content usage rights of the at least one flexible structure component for the requesting remote site or remote client device prior to further distribution to the requesting remote locations or remote client devices;
delegating the rights for defining the content usage rights for the requesting remote locations or remote client devices prior to further distribution to the requesting remote locations/client devices; and
securely controlling the operation of the flexible structure component by an at least one flexible structure component controller.

29. The method as claimed in claim 28 wherein the definition of the usage rights is performed without the establishment of a communication link to a supplier remote location/controller remote location.

30. The method as claimed in claim 28 wherein the delegation of the rights for defining the content usage rights is performed without the establishment of a communication link to a supplier remote location/controller remote location.

31. The method as claimed in claim 28 wherein the communications network is a data network.

32. The method as claimed in claim 31 wherein the communications network is a Wide Are Network.

33. The method as claimed in 32 wherein the communication network is a Local Area Network.

34. The method as claimed in claim 33 wherein the communications network is a cellular network.

35. The method as claimed in claim 28 wherein the element of the digital product supply chain is a digital product owner or digital product distributor.

36. The method as claimed in claim 28 wherein the element of the digital product supply chain is a reseller.

37. The method as claimed in claim 28 wherein the element of the digital product distribution network is a consumer.

38. The system as claim in claim 1 wherein the service device is linked to a digital product archive device.

39. The method as claimed in claim 28 wherein the basic product rules, definitions and limitations are defined by the digital product owner or the digital product distributor in a comprehensive manner and are embedded into the digital product during assembling of the flexible structure component.

40. The method as claimed in claim 28 wherein the reseller element of the digital product chain is provided with the capability of enhanced control concerning the digital product usage rights.

41. The method as claimed in claim 28 wherein the consumer element of the digital product supply chain is provided with the capability of limited control concerning the digital product usage rights.
